(19) United States
(12) Patent Application Publication
(10) Pub. No.: US 2016/0108728 A1
(43) Pub. Date: Apr. 21, 2016

(54) INTEGRATED COMPUTATIONAL ELEMENT-BASED OPTICAL SENSOR NETWORK AND RELATED METHODS

(71) Applicant: HALLIBURTON ENERGY SERVICES INC., Houston, TX (US)

(72) Inventors: Robert P. Freese, Pittsboro, NC (US); Tim Tips, Houston, TX (US); Matt Scogin, Houston, TX (US); Paul Robert Terry, Spring, TX (US)

(73) Assignee: Halliburton Energy Services, Inc., Houston, TX (US)

(21) Appl. No.: 14/787,067

(22) PCT Filed: Jun. 20, 2013
(86) PCT No.: PCT/US13/46877

§ 371 Date: Oct. 26, 2015

(51) Int. Cl. E21B 49/08; G01V 8/20; E21B 47/12

(52) U.S. Cl. CPC E21B 49/08; E21B 47/12; G01V 8/20

(57) ABSTRACT

An optical sensor network utilizing Integrated Computational Elements (“ICE”) provides the capability to measure chemical compositions in a variety of application environments in real-time. In one exemplary application, the network comprises a plurality of ICE modules distributed throughout a downhole well environment. The ICE modules are communicably coupled to a computer station which controls the operation and power consumption of the ICE modules. The computer station may selectively activate and deactivate one or more of the ICE modules to regulate power consumption and/or may select the optimal ICE modules to activate at any given time.

### FIELD OF THE INVENTION

The present invention relates generally to optical sensors networks and, more specifically, to an Integrated Computational Element (“ICE”) based sensor network for use in a variety of energy or power constrained applications.

### BACKGROUND

Conventionally, no techniques are available that measure the chemical compositions of wellbore fluids in a downhole, distributed fashion. To date, the power requirements for sensors that may be utilized in such a network have been too high. In addition, there have been no sensors available to provide fluid chemistry data in real-time.

Accordingly, there is a need in the art for an optical sensor network that is useful in a variety of power constrained environments and provides real time chemical compositional measurements of samples within a given environment.

### BRIEF DESCRIPTION OF THE DRAWINGS

FIG. 1A illustrates an ICE-based sensor network distributed along a downhole well according to certain exemplary embodiments of the present invention;

FIG. 1B illustrates a decentralized network which may be utilized as the communications architecture for an ICE-based sensor network according to certain exemplary embodiments of the present invention;

FIG. 1C illustrates a distributed network which may be utilized as the communications architecture for an ICE-based sensor network according to certain exemplary embodiments of the present invention;

FIG. 2 is a block diagram of an ICE module employing a transmission mode design, according to certain exemplary embodiments of the present invention;

FIG. 3 is a block diagram of another ICE module employing a time domain mode design, according to certain exemplary embodiments of the present invention;

FIG. 4 illustrates an ICE module 22 which is affixed to tubulars extending along a downhole well, according to certain exemplary embodiments of the present invention; and

FIG. 5 is a flow chart of a methodology performed by a distributed network in accordance to certain exemplary methods of the present invention.

### DESCRIPTION OF ILLUSTRATIVE EMBODIMENTS

Illustrative embodiments and related methodologies of the present invention are described below as they might be employed in an ICE-based sensor network for use in a variety of environments. In the interest of clarity, not all features of an actual implementation or methodology are described in this specification. Also, the “exemplary” embodiments described herein refer to examples of the present invention. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure. Further aspects and advantages of the various embodiments and related methodologies of the invention will become apparent from consideration of the following description and drawings.

Exemplary embodiments of the present invention are directed to an ICE-based sensor network that may be utilized in any environment which is energy or power constrained, such as, for example, downhole well monitoring systems. The sensor network is comprised of a plurality of ICE computing devices (referred to herein as “ICE modules”) positioned at desired locations along the network. The ICE modules described herein utilize one or more ICE structures, also known as a Multivariate Optical Elements (“MOE”) or ICE cores, to achieve the objectives of the present invention. The ICE modules are configured to receive an input of electromagnetic radiation from a substance or sample of the substance and produce an output of electromagnetic radiation from a processing element. Fundamentally, ICE modules utilize ICE structures to perform calculations, as opposed to the hardwired circuits of conventional electronic processors. When electromagnetic radiation interacts with a substance, unique physical and chemical information about the substance is encoded in the electromagnetic radiation that is reflected from, transmitted through, or radiated from the sample. Thus, the ICE module, through use of the ICE structure, is capable of extracting the information of one or multiple characteristics/properties or analytes within a substance and converting that information into a detectable output regarding the overall properties of a sample.

Further discussion of the design and operation of ICE structures can be found in, for example, U.S. Pat. No. 6,198,531, entitled “OPTICAL COMPUTATIONAL SYSTEM,” issued to Myrick et al. on Mar. 6, 2001; U.S. Pat. No. 7,697,141, entitled “IN SITU OPTICAL COMPUTATION FLUID ANALYSIS SYSTEM AND METHOD,” issued to Jones et al. on Apr. 13, 2010; and U.S. Pat. No. 8,049,881, entitled “OPTICAL ANALYSIS SYSTEM AND METHODS FOR OPERATING MULTIVARIATE OPTICAL ELEMENTS IN A NORMAL INCIDENCE ORIENTATION,” issued to Myrick et al. on Nov. 1, 2011, each being owned by the Assignee of the present invention, Halliburton Energy Services, Inc., of Houston, Tex., the disclosure of each being hereby incorporated by reference in its entirety.

As described herein, the exemplary ICE-based sensor networks may comprise hundreds or thousands of ICE modules. Power may be supplied to the ICE modules from a remote power supply or a battery pack on-board each ICE module. To conserve power in certain embodiments, each individual ICE module consumes, for example, roughly 2 Watts of power continuously. Each ICE module may be activated and deactivated readily (every 10 seconds, for example), In addition, power may be supplied to a selected set of ICE modules simultaneously or to individuals ICE modules in a round robin fashion, thereby enabling the acquisition of thousands of measurements while staying within a desired average total power threshold (10 Watts, for example). In yet another alternative embodiment, similar techniques may be applied to power constrained (e.g. battery operated) ICE modules such as, for example, pipeline pigs, undersea or terrestrial robots, satellites, drones and missiles or other aircraft, buoys or undersea sensors, ingested body sensors, and the like.

The exemplary ICE-based sensor networks described herein may be utilized in many different environments. Such environments may include, for example, downhole well or completion applications. Other environments may include those as diverse as those associated with surface and undersea monitoring, satellite or drone surveillance, pipeline monitoring, or even sensors transiting a body cavity such as a digestive tract. Within those environments, the ICE modules are utilized to detect various compounds or characteristics in order to monitor, in real time, various phenomena occurring within the network. In certain embodiments, the compounds and/or fluid characteristics data is utilized to generate real-time event maps or alerts reflecting the network phenomena that is indicated by the compound/characteristic data received from the ICE modules.

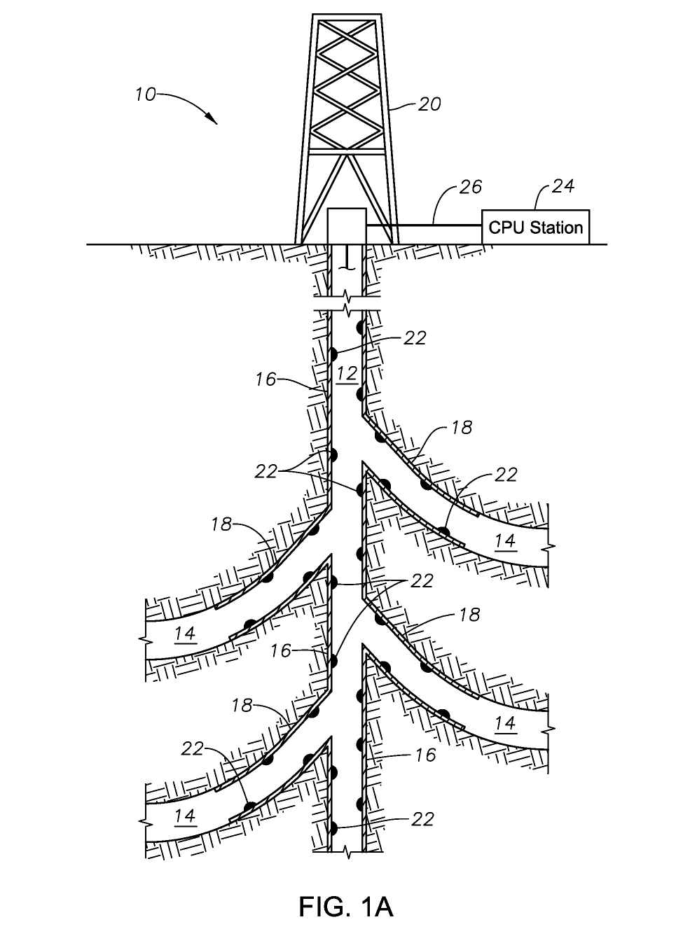

Although the ICE-based networks described herein may be utilized in a variety of environments, the following description will focus on downhole well applications. FIG. 1A illustrates an ICE-based sensor network distributed along a downhole well system 10 according to certain exemplary embodiments of the present invention. Well system 10 comprises a vertical wellbore 12 having a plurality of lateral wellbores 14 extending from vertical wellbore 12. Wellbore equipment 20 is positioned atop vertical wellbore 12, as understood in the art. Wellbore equipment may be, for example, a blow out preventer, derrick, floating platform, etc. As understood in the art, after vertical wellbore 12 is formed and tubulars 16 (casing, for example) are extended therein, lateral wellbores 14 are then formed using a diverter (whipstock, for example) and drilled accordingly. Thereafter, a string of tubulars 18 are positioned along lateral wellbore 14 in order to complete the lateral sections, as also understood in the art.

Well system 10 includes an ICE-based sensor network comprised of a plurality of ICE modules 22 communicably coupled to a CPU station 24 via a communications link 26. ICE modules 22 are distributed throughout well system 10 as desired. In certain embodiments, for example, each ICE module 22 is 1-inch in diameter and spaced 10-20 feet apart. In other embodiments, at least one ICE module 22 is positioned along each tubular section to increase the resolution of the network. However, other embodiments may include more than one ICE module 22 per tubular section, such as, for example, a circular array design or simply putting more than one ICE sensor along the pipe length. Furthermore, tubular sections with or without ICE modules 22 can be strung together to achieve optimal results. Those ordinarily skilled in the art having the benefit of this disclosure will readily appreciate that the network resolution may be manipulated as desired via the number and spatial placement of the ICE modules.

As will be described in more detail later, each ICE module 22 comprises an ICE structure that optically interacts with a sample of interest (wellbore fluid, for example) to determine a characteristic of the sample. In certain exemplary embodiments, the characteristics determined include the presence and quantity of specific inorganic gases such as, for example, CO₂ and H₂S, organic gases such as methane (C1), ethane (C2) and propane (C3) and saline water, in addition to dissolved ions (Ba, Cl, Na, Fe, or Sr, for example) or various other characteristics (p.H., density and specific gravity, viscosity, total dissolved solids, sand content, etc.). In certain embodiments, a single ICE module 22 may detect a single characteristic, while in others a single ICE module 22 may determine multiple characteristics, as will be understood by those ordinarily skilled in the art having the benefit of this disclosure.

The ICE-based network communications architecture may take on a variety of forms, such as, for example, a centralized, decentralized or distributed form. In those embodiments using a centralized network, each ICE module 22 is directly coupled to CPU station 24 via communications link 26. In a decentralized network, one or more groups of ICE modules 22 may be communicably coupled to one another via a node (another ICE module, for example), and the nodes are then communicably coupled to CPU station 24 via communications link 26. FIG. 1B illustrates an example of a decentralized network which may be utilized as the communications architecture for an ICE-based network of the present invention. As shown, any number of ICE modules 22 may be communicably coupled via links 23 along the network.

In distributed network architecture, any number of alternative routings may exist between each ICE modules 22 and CPU station 24. FIG. 1C illustrates an example of a distributed network which may be utilized as the communications architecture for an ICE-based network of the present invention. The network of FIG. 1C is similar to that of FIG. 1B, except that there are far more alternate communications links 23 over which to communicate. Further design and operation of each alternative network architecture will be readily understood by those ordinarily skilled in the art having the benefit of this disclosure.

Referring back to FIG. 1A, CPU station 24 comprises a signal processor (not shown), communications module (not shown) and other circuitry necessary to achieve the objectives of the present invention, as will be understood by those ordinarily skilled in the art having the benefit of this disclosure. In addition, it will also be recognized that the software instructions necessary to carry out the objectives of the present invention may be stored within storage located in CPU station 24 or loaded into that storage from a CD-ROM or other appropriate storage media via wired or wireless methods. Communications link 26 provides a medium of communication between CPU station 24 and ICE modules 22. Communications link 26 may be a wired link, such as, for example, a wireline extending down into vertical wellbore 12 and lateral wellbores 14 or a fiber optic cable. Alternatively, however, communications link 26 may be a wireless link, such as, for example, an electromagnetic device of suitable frequency, or other methods including acoustic communication and like devices.

CPU station 24, via its signal processor, controls operation of each ICE module 22 along the distributed network. ICE modules 22 each include a transmitter and receiver (transceiver, for example) (not shown) that allows bi-directional communication over communications link 26 in real time. In certain exemplary embodiments, ICE modules 22 will transmit all or a portion of the sample characteristic data to CPU station 24 for further analysis. However, in other embodiments, such analysis is completely handled by each ICE module 22 and the resulting data is then transmitted to CPU station 24 for storage or subsequent analysis.

In addition, CPU station 24 comprises a power management module (not shown) utilized by the signal processor to activate/deactivate ICE modules 22, thus controlling power consumption of the network. In certain embodiments, ICE modules 22 are coupled to a remote power supply (located on the surface or a power generator positioned downhole along the wellbore, for example), while in other embodiments each ICE module 22 comprises an on-board battery. Nevertheless, to control power consumption, certain embodiments of the power management module execute a scheduling algorithm that allocates a time slot to each ICE module 22. During an allocated time slot, the assigned ICE module 22 is allocated power and other system resources necessary to conduct sensing operations. In certain exemplary embodiments, the scheduling algorithm may activate and deactivate one or more of ICE modules 22 in a round-robin, sequential, or random manner, at any given time. Those ordinarily skilled in the art having the benefit of this disclosure realize these and other resource scheduling methodologies may be utilized with the present invention.

In another exemplary embodiment, the power management module activates and deactivates one or more of ICE modules 22 such that total power consumption within the network at any given time does not exceed a certain threshold. For example, in one embodiment, the total network wattage available at any given time is 10 Watts max and each ICE module 22 requires roughly 2 Watts of power. Thus, only five ICE modules 22 may be operated at once. In such an embodiment, the power management module may utilize a scheduling algorithm to activate only five ICE modules 22 for a selected time period (10 seconds, for example). At the completion of the selected time period, CPU station 24 will deactivate those five ICE modules 22 and then activate another set of five ICE modules 22. This activation/deactivation process may continue in a round-robin fashion or as otherwise desired based upon the operator's desire or historical record of interest. Moreover, in an alternative embodiment as described below, CPU station 24 utilizes the power management module to determine the optimal ICE modules 22 to activate and when to activate those ICE modules 22.

Still referring to FIG. 1A, ICE modules 22 are distributed along vertical wellbore 12 and lateral wellbores 14. In the exemplary embodiment illustrated, ICE modules 22 are affixed to the inner diameter of tubulars 16 and 18. ICE modules 22 have a temperature and pressure resistant housing sufficient to withstand the harsh downhole environment. A variety of materials may be utilized for the housing, including, for example, stainless steels and their alloys, titanium and other high strength metals, and even carbon fiber composites and sapphire or diamond structures, as understood in the art. In certain exemplary embodiments, ICE modules 22 form part of tubulars 16,18. Alternatively, ICE modules 22 may be permanently affixed to the inner diameter of tubulars 16,18 by a welding or other suitable process. However, in yet another embodiment, ICE modules 22 are removably affixed to the inner diameter of tubulars 16,18 using magnets or physical structures so that ICE modules 22 may be periodically removed for service purposes or otherwise.

Those ordinarily skilled in the art having the benefit of this disclosure realize the ICE modules described herein may be housed or packaged in a variety of ways. In addition to those described herein, exemplary housings also include those described in Patent Cooperation Treaty Application No. ______, filed on Jun. 20, 2013, entitled “IMPLEMENTATION CONCEPTS AND RELATED METHODS FOR OPTICAL COMPUTING DEVICES, the disclosure of which is hereby incorporated by reference in its entirety.

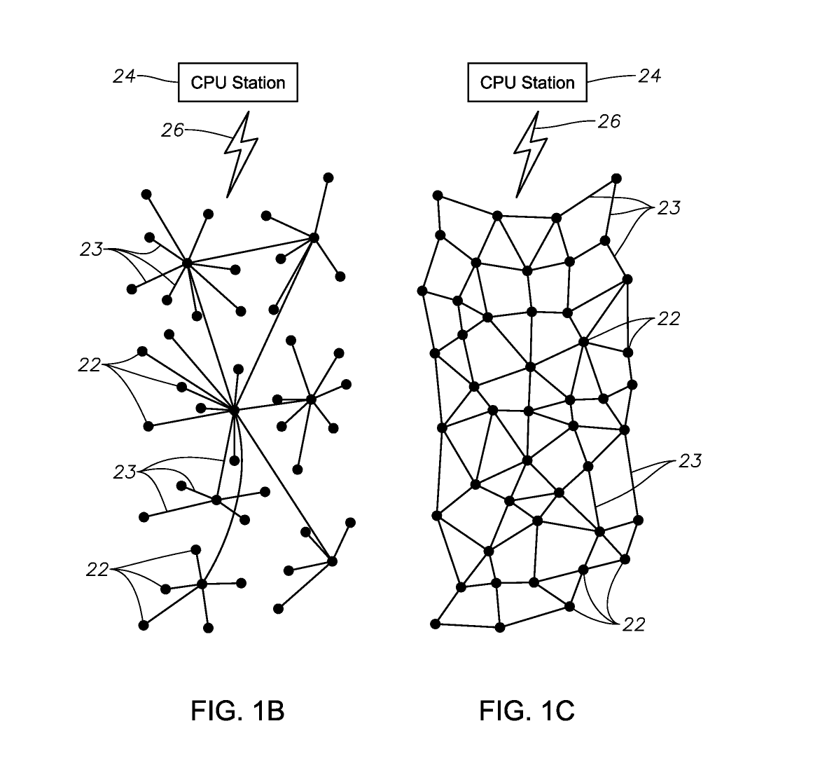

FIG. 2 is a block diagram of an ICE module 200 employing a transmission mode design, according to certain exemplary embodiments of the present invention. An electromagnetic radiation source 208 may be configured to emit or otherwise generate electromagnetic radiation 210. As understood in the art, electromagnetic radiation source 208 may be any device capable of emitting or generating electromagnetic radiation. For example, electromagnetic radiation source 208 may be a light bulb, light emitting device, laser, blackbody, photonic crystal, or X-Ray source, etc. In one embodiment, electromagnetic radiation 210 may be configured to optically interact with the sample 206 (wellbore fluid flowing through wellbores 12,14, for example) and generate sample-interacted light 212 directed to a beam splitter 202. Sample 206 may be any fluid (liquid or gas), solid substance or material such as, for example, rock formations, slurries, sands, muds, drill cuttings, concrete, other solid surfaces, etc. In this specific embodiment, however, sample 206 is a multiphase wellbore fluid (comprising oil, gas, water, solids, for example) consisting of a variety of fluid characteristics such as, for example, C1-C4 and higher hydrocarbons, groupings of such elements, and saline water.

Sample 206 may be provided to ICE module 200 through a flow pipe or sample cell, for example, containing sample 206, whereby it is introduced to electromagnetic radiation 210. While FIG. 2 shows electromagnetic radiation 210 as passing through or incident upon the sample 206 to produce sample-interacted light 212 (i.e., transmission or fluorescent mode), it is also contemplated herein to reflect electromagnetic radiation 210 off of the sample 206 (i.e., reflectance mode), such as in the case of a sample 206 that is translucent, opaque, or solid, and equally generate the sample-interacted light 212.

After being illuminated with electromagnetic radiation 210, sample 206 containing an analyte of interest (a characteristic of the sample, for example) produces an output of electromagnetic radiation (sample-interacted light 212, for example). Although not specifically shown, one or more spectral elements may be employed in ICE module 200 in order to restrict the optical wavelengths and/or bandwidths of the system and, thereby, eliminate unwanted electromagnetic radiation existing in wavelength regions that have no importance. As will be understood by those ordinarily skilled in the art having the benefit of this disclosure, such spectral elements can be located anywhere along the optical train, but are typically employed directly after the light source which provides the initial electromagnetic radiation.

Still referring to the exemplary embodiment of FIG. 2, beam splitter 202 is employed to split sample-interacted light 212 into a transmitted electromagnetic radiation 214 and a reflected electromagnetic radiation 220. Transmitted electromagnetic radiation 214 is then directed to one or more optical elements 204. Optical element 204 may be a variety of optical elements such as, for example, one or more narrow band optical filters or ICEs arranged or otherwise used in series in order to determine the characteristics of sample 206. In those embodiments using ICEs, the ICE may be configured to be associated with a particular characteristic of sample 206 or may be designed to approximate or mimic the regression vector of the characteristic in a desired manner, as would be understood by those ordinarily skilled in the art having the benefit of this disclosure. Additionally, in an alternative embodiment, optical element 204 may function as both a beam splitter and computational processor, as will be understood by those same ordinarily skilled persons.

Nevertheless, transmitted electromagnetic radiation 214 then optically interacts with optical element 204 to produce optically interacted light 222. In this embodiment, optically interacted light 222, which is related to the characteristic or analyte of interest, is conveyed to detector 216 for analysis and quantification. Detector 216 may be any device capable of detecting electromagnetic radiation, and may be generally characterized as an optical transducer. For example, detector 216 may be, but is not limited to, a thermal detector such as a thermopile or photoacoustic detector, a semiconductor detector, a piezo-electric detector, charge coupled device detector, video or array detector, split detector, photon detector (such as a photomultiplier tube), photodiodes, and/or combinations thereof, or the like, or other detectors known to those ordinarily skilled in the art. Detector 216 is further configured to produce an output signal 228 in the form of a voltage that corresponds to the particular characteristic of the sample 206. In at least one embodiment, output signal 228 produced by detector 216 and the concentration of the characteristic of the sample 206 may be directly proportional. In other embodiments, the relationship may be a polynomial function, an exponential function, and/or a logarithmic function.

ICE module 200 includes a second detector 218 arranged to receive and detect reflected electromagnetic radiation and output a normalizing signal 224. As understood in the art, reflected electromagnetic radiation 220 may include a variety of radiating deviations stemming from electromagnetic radiation source 208 such as, for example, intensity fluctuations in the electromagnetic radiation, interferent fluctuations (for example, dust or other interferents passing in front of the electromagnetic radiation source), combinations thereof, or the like. Thus, second detector 218 detects such radiating deviations as well. In an alternative embodiment, second detector 218 may be arranged to receive a portion of the sample-interacted light 212 instead of reflected electromagnetic radiation 220, and thereby compensate for electromagnetic radiating deviations stemming from the electromagnetic radiation source 208. In yet other embodiments, second detector 218 may be arranged to receive a portion of electromagnetic radiation 210 instead of reflected electromagnetic radiation 220, and thereby likewise compensate for electromagnetic radiating deviations stemming from the electromagnetic radiation source 208. Those ordinarily skilled in the art having the benefit of this disclosure will realize there are a variety of design alterations which may be utilized in conjunction with the present invention.

Although not shown in FIG. 2, in certain exemplary embodiments, detector 216 and second detector 218 may be communicably coupled to a signal processor (not shown) on-board ICE module 200 such that normalizing signal 224 indicative of electromagnetic radiating deviations may be provided or otherwise conveyed thereto. The signal processor may then be configured to computationally combine normalizing signal 224 with output signal 228 to provide a more accurate determination of the characteristic of sample 206. However, in other embodiments that utilized only one detector, the signal processor would be coupled to the one detector. Nevertheless, in the embodiment of FIG. 2, for example, the signal processor computationally combines normalizing signal 224 with output signal 228 via principal component analysis techniques such as, for example, standard partial least squares which are available in most statistical analysis software packages (for example, XL Stat for MICROSOFT® EXCEL®; the UNSCRAMBLER® from CAMO Software and MATLAB® from MATHWORKS®), as will be understood by those ordinarily skilled in the art having the benefit of this disclosure. Thereafter, the resulting data is then transmitted to CPU station 24 via communications link 26 for further operations.

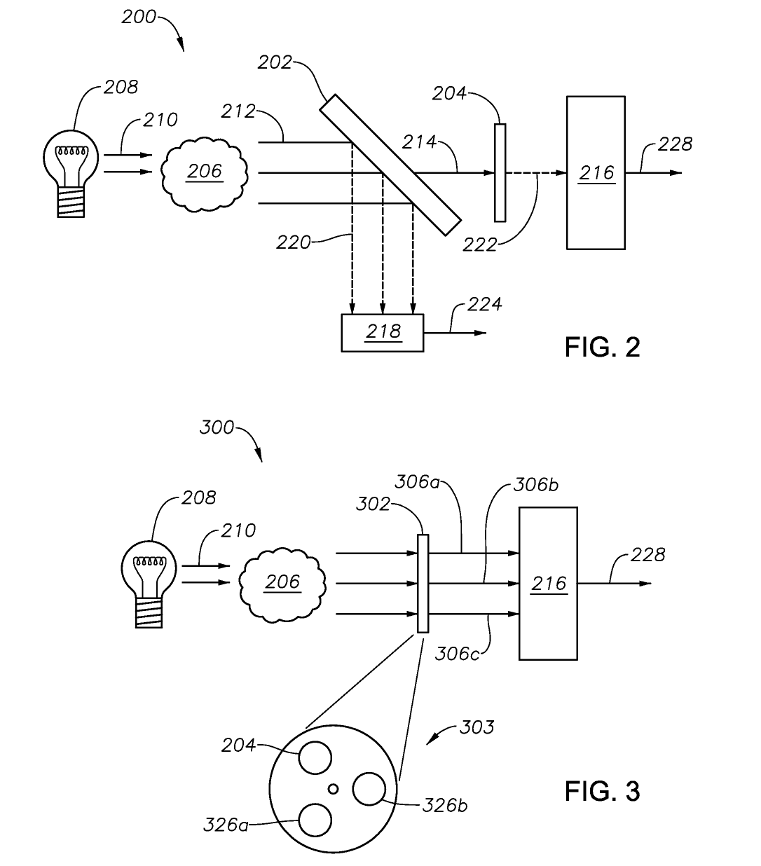

FIG. 3 illustrates a block diagram of yet another ICE module 300 employing a time domain mode design, according to certain exemplary embodiments of the present invention. ICE module 300 is somewhat similar to ICE module 200 described with reference to FIG. 2 and, therefore, may be best understood with reference thereto, where like numerals indicate like elements. ICE module 300 may include a movable assembly 302 having at least one optical element 204 and two additional optical elements 326a and 326b associated therewith. As illustrated, the movable assembly 302 may be characterized at least in one embodiment as a rotating disc 303, such as, for example, a chopper wheel, wherein optical elements 204, 326a and 326b are radially disposed for rotation therewith. FIG. 3 also illustrates corresponding frontal views of the moveable assembly 302, which is described in more detail below.

Those ordinarily skilled in the art having the benefit of this disclosure will readily recognize, however, that movable assembly 302 may be characterized as any type of movable assembly configured to sequentially align at least one detector with optically interacted light and/or one or more optical elements. Each optical element 204, 326a and 326b may be similar in construction to those as previously described herein, and configured to be either associated or disassociated with a particular characteristic of the sample 206. Although three optical elements are described, more or less optical elements may be employed along movable assembly 302 as desired.

In certain exemplary embodiments, rotating disc 303 may be rotated at a frequency of about 0.1 RPM to about 30,000 RPM. In operation, rotating disc 303 may rotate such that the individual optical elements 204, 326a and 326b may each be exposed to or otherwise optically interact with the sample-interacted light 212 for a distinct brief period of time. Upon optically interacting with the sample-interacted light 212, optical element 204 is configured to generate optically interacted light 306a (a first beam, for example), optical element 326a is configured to generate a second optically interacted light 306b (a second beam, for example) and optical element 326b is configured to generate a normalized electromagnetic radiation 306c (a normalization beam, for example). Detector 216 then receives each beam 306a-c and thereby generates a first, second and third output signal, respectively (output signal 228 comprises the first, second and third signals). Accordingly, a signal processor (not shown) communicatively coupled to detector 216 utilizes the output signal to computationally determine the sample characteristics.

Moreover, in certain exemplary embodiments, detector 216 may be configured to time multiplex beams 306a-c between the individually-detected beams. For example, optical element 204 may be configured to direct first beam 306a toward the detector 216 at a first time T1, optical element 326a may be configured to direct second beam 306b toward the detector 216 at a second time T2, and optical element 326b may be configured to direct third beam 306c toward detector 216 at a third time T3. Consequently, detector 216 receives at least three distinct beams of optically-interacted light which may be computationally combined by a signal processor (not shown) coupled to detector 216 in order to provide an output in the form of a voltage that corresponds to the characteristic of the sample, as previously described. In certain alternate embodiments, beams 306a-c may be averaged over an appropriate time domain (for example, about 1 millisecond to about 1 hour) to more accurately determine the characteristic of sample 206. As previously described, detector 216 is positioned to detect first, second and third beams 306a-c in order to produce output signal 228. In this embodiment, a signal processor (not shown) may be communicably coupled to detector 216 such that output signal 228 may be processed as desired to computationally determine one or more characteristics of sample 206.

Those ordinarily skilled in the art having the benefit of this disclosure realize the aforementioned ICE modules are exemplary in nature, and that there are a variety of other optical configurations which may be utilized. These optical configurations not only include the reflection, absorption or transmission methods described herein, but can also involve scattering (Raleigh & Raman, for example) as well as emission (fluorescence, X-ray excitation, etc., for example). In addition, the ICE module may comprise a parallel processing configuration whereby the sample-interacted light is split into multiple beams. The multiple beams may then simultaneously go through corresponding ICE elements, whereby multiple analytes of interest are simultaneously detected. The parallel processing configuration is particularly useful in those applications that require extremely low power or no moving parts. In yet another alternate embodiment, various single or multiple ICE may be positioned in series in a single ICE module. This embodiment is particularly useful if it is necessary to measure the concentrations of the analytes in different locations (in each individual mixing pipe, for example). It is also sometimes helpful if each of the ICE structures use two substantially different light sources (UV and IR, for example) to cover the optical activity of all the analytes of interest (i.e., some analytes might be only UV active, while others are IR active). Nevertheless, those ordinarily skilled in the art having the benefit of this disclosure will realize the choice of a specific optical configuration is mainly dependent upon the specific application and analytes of interest.

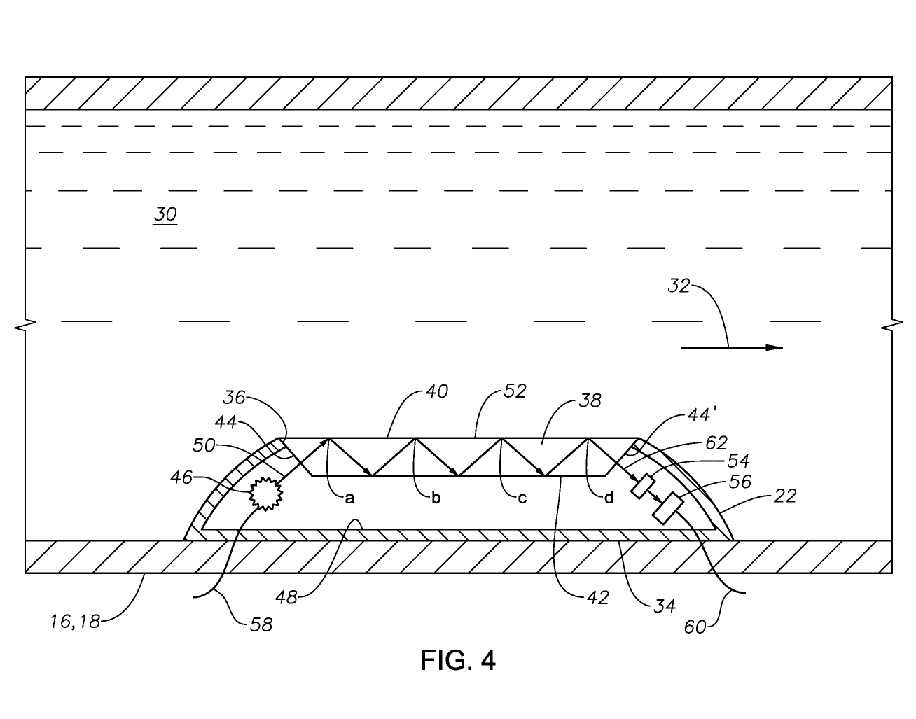

FIG. 4 illustrates an ICE module 22, forming part of an ICE-based network, which is attached to tubulars 16 and/or tubulars 18 of FIG. 1A, according to certain exemplary embodiments of the present invention. In FIG. 4, exemplary ICE module 22 utilizes yet another optical configuration consisting of an internal reflectance element. In this example, ICE module 22 is dome-shaped (akin to a vehicle dome light) and has been attached to the inner diameter of tubulars 16,18 using a suitable method (welding, magnets, etc.). A multiphase wellbore fluid 30 is flowing through tubular 16,18 in direction 32. ICE module 22 may be any one of the ICE modules 200, 300 or other optical configurations described herein, and is utilized for determining characteristics of multiphase wellbore fluid 30. In this exemplary embodiment, ICE module 22 determines the amount of the characteristic for which it is attune in real-time and reports that data as it occurs in flowing fluid 30 to CPU station 24. ICE module 22 forms part of the ICE-based network of FIG. 1A. Therefore, although not shown, any number of additional ICE modules 22 may be communicably coupled thereto and positioned throughout well system 10, as shown in FIG. 1A.

Still referring to FIG. 4, ICE module 22 comprises a dome-shaped housing 34 which may be stainless steel, magnetized and consist of one or more protective coatings. In certain exemplary embodiments, housing 34 is magnetic so that it is readily attached and detached from tubular 16,18. Housing 34 further comprises an opening 36 forming a window transparent to light, including the IR spectrum, whereby an internal reflectance element (“IRE”) 38 is positioned. IRE 38 may be, for example, an optically transparent disc, prism, or other shape, or a pair of spaced optically transparent plates (not shown), that are attached to housing 34 in the opening 36, thereby enclosing and sealing opening 36. IRE 38 may be bonded or attached to housing 34 using any suitable method. In certain embodiments, IRE 38 may have a thickness of about 1-2 mm and a diameter of about 10-20 mm when fabricated of diamond.

IRE 38 has two spaced parallel planar surfaces 40 and 42, and an outer annular inclined facet 44, defined by the critical angle of total internal reflection, dependent upon the materials of the interface and wavelength of the light, to the surfaces 40 and 42. An electromagnetic radiation source 46 is located in housing cavity 48 to cause its electromagnetic radiation 50 to be incident on facet 44 at a right angle thereto. Facet 44 is also at the critical angle to surface 52 of multiphase fluid 30 flowing in tubular 16,18 contiguous with IRE surface 40. IRE 38 and housing 34 may seal the tubular opening in conjunction with, for example, a gasket, etc. (not shown). The attachment of housing 58 to tubular 16,18 will also be sufficient to withstand anticipated pressures.

Located within housing cavity 48 is an optical element 54 (ICE, for example) and detector 56 that is responsive to the output of optical element 54 for generating an electrical intensity output signal whose value corresponds to a characteristic of the multiphase fluid being determined, as previously described herein. A conductor 58 supplies power to electromagnetic radiation source 46 and a conductor 60 receives the detector output signal. As previously described, the power source may be located on-board ICE module 22 or located remotely. In either embodiment, the power consumption of ICE module 22 is controlled by the power management module of CPU station 24, as also described previously.

Conductor 60 may also be connected to an on-board signal processor (not shown) for determining the characteristic of the fluid manifested by the signal on conductor 60. The signal processor may then communicate the characteristic data over communications link 26 (not shown) which is also connected to ICE module 22. Alternatively, ICE module 22 may simply transmit the output signal over communications link 26 to CPU station 24 for further analysis. Moreover, a transparent fluid (not shown) in housing cavity 48 may be pressurized to balance the pressure of the petroleum in the tubular 16,18 to prevent leakages there between.

Still referring to FIG. 4, during operation of ICE based network (FIG. 1A), electromagnetic radiation 50 is transmitted by IRE 38 to the surface 52 of the flowing multiphase fluid in tubular 16,18. Electromagnetic radiation 50 incident on and reflected from the fluid surface 52 will penetrate the surface 52 a few micrometers, e.g., 0.3-5 microns. That penetration into fluid surface 52 must be to at least a depth of about 40 microns for the reflected interacted light from the fluid surface 52 to carry sufficient wavelength information about the measured characteristics. The total path length requirements change depending upon the component being analyzed, the characteristics of the fluid flow, sample type, presence and amounts of gas-liquid-solid phases, water phases, and so on, as will be understood by those ordinarily skilled in the art having the benefit of this disclosure.

As a result, electromagnetic radiation 50 is reflected from multiphase fluid surface 52 and penetrates surface 52 to about 5 micrometers at location a. This reflected light from location a is interacted light and is reflected to the inner surface of surface 42 of IRE 38 to produce further interacted light. Refraction indices of IRE 38 cause the interacted light to be reflected from the surface 42 back through IRE 38 to the fluid surface 52 at location b again penetrating to a depth of about 5 micrometers. This reflection process is repeated at locations c and d and other locations (not shown) until an accumulated depth of about 40 micrometers for all of the interactions is achieved. At the last location d, in this example, the reflected interacted light from the fluid surface 52 is incident on IRE facet 44 at location 44′. Here, reflected light 62 is normal to the facet of IRE 38 and passes through the facet 44′. Reflected light 62 is incident on optical element 54 and passes through optical element 54 to detector 56. It should be understood that a second detector (not shown) may also be responsive to reflected light from optical element 54 and supplied to a further conductor (not shown) and signal processor for further processing.

In certain exemplary embodiments, housing 34, and thus ICE module 22, may be 1-inch in diameter. However, depending upon the optical configuration, any given ICE module 22 may be larger or smaller. Moreover, ICE module 22 may take a variety of other forms, such as, for example, forming part of tubular 16,18 and having conduits for extracting fluid samples from the wellbore fluid flowing through tubular 16,18. Nevertheless, separate ICE modules 22 are distributed along the ICE-based network in order to detect each characteristic in the wellbore fluid. As previously described, each ICE module may be communicably coupled to another via a suitable network communications architecture (centralized, decentralized, distributed, etc., for example). CPU station 24 is also communicably coupled to the ICE modules to control operation of each and to regulate power consumption. Accordingly, the ICE-based network detects various compound or fluid characteristics in real-time.

In view of the foregoing description, an exemplary operation of the ICE-based network of the present invention will now be described. As stated throughout this description, the ICE-based networks described herein may be utilized in a variety of applications. In one such application, the ICE-based network is deployed in a downhole well as part of a monitoring system. The network comprises a plurality of ICE modules affixed to tubulars throughout the well, and a CPU station. In this exemplary methodology, the ICE modules are communicably coupled to one another and the CPU station in a round-robin fashion.

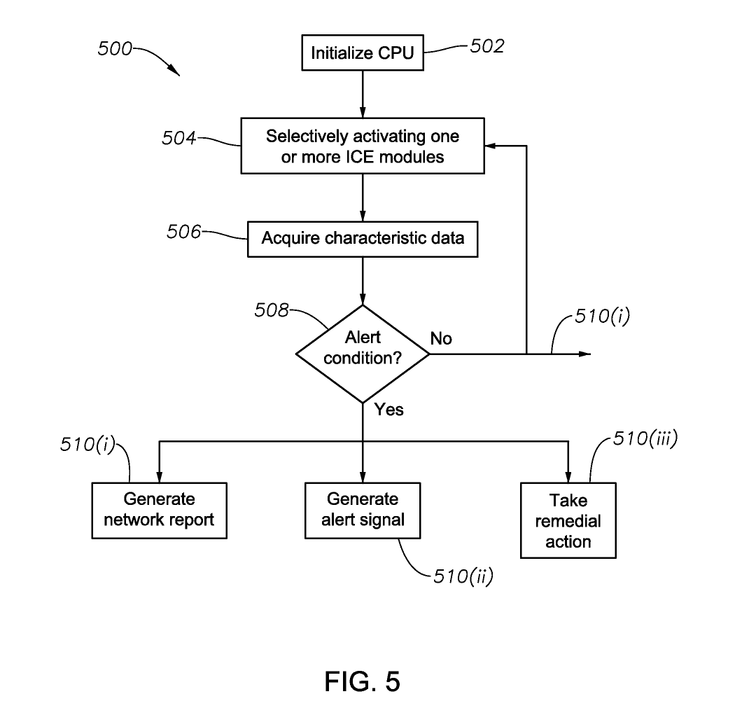

FIG. 5 is a flow chart of an exemplary method 500 of the present invention. When it is desired to perform sensing operations, CPU station 24 initializes at block 502 and, through utilization of a power management module, selectively activates one or more of the ICE modules at block 504. As wellbore fluid or other compounds flow through the well and past the activated ICE modules, the optical elements contained therein optically interact with the fluid to acquire and determine a characteristic of the fluid at block 506. The resulting characteristic data generated by the ICE modules is then transmitted to the CPU station for further processing in real-time.

In certain other methodologies, the CPU station will determine whether the characteristic data indicates an alert condition at block 508 (out of range conditions, interrupted flow conditions, etc., for example). For example, a sudden influx of water into an oil collection tubular may be detected. Similarly, a sudden influx of gas (either dissolved or not), such as methane or H2S, could presage an extremely dangerous or toxic event when the fluid reaches the surface. Detection of such an event would enable operators to shut appropriate values or employ other techniques to reduce the danger. If such an alert condition is detected at block 508, the CPU station will then generate an alert signal that is transmitted to some remote device (hand held device, warning siren, display, etc., for example) at block 510(ii). Alternatively, the CPU station may perform remedial action, such as, for example, shutting off the tubular (an “intelligent” valve, for example) in which the alert condition was detected at block 510(iii). In yet other methodologies, the CPU station may generate a network report at block 510(i), such as, for example, real time maps of downhole conditions and events based on the characteristic data received from the ICE modules. However, if at block 508, the CPU station determines there is no alert condition, the process may continue back to blocks 504 and/or block 510(i).

Referring back to block 504, certain exemplary methodologies of the present invention determines the optimal use of ICE modules 22 along the network. As previously mentioned, CPU station 24 may utilize the power management module to determine the optimal ICE modules 22 to activate and when to activate those ICE modules 22. For example, if there is little known information about the formation per se when installing the collection tubulars, ICE modules 22 may be distributed along the tubulars uniformly in all directions and in a somewhat uniform pattern. Not knowing what to expect when the completion is operating and fluids are flowing, CPU station 24 may begin activating ICE modules 22 in a round-robin sensing pattern. At some juncture, however, CPU station 24 receives data from ICE modules 22 indicating water intrusion along the tubulars 16,18. CPU station 24 may then begin selectively activating certain ICE modules 22 to locate the source of the intrusion. Once determined, using the power management module, CPU station 24 may begin activating those ICE modules adjacent the intrusion source more frequently to assess the viability of the remediation at block 510(iii). In addition, CPU station 24 might also more frequently activate those ICE modules 22 along the neighboring tubulars 16,18. Therefore, in one methodology, real-time data is utilized by CPU station 24 to determine which ICE modules 22 to activate, as well as the length of measurement and frequency of measurement. Alternatively, CPU station 24 may also selectively activate ICE modules 22 based upon production experience.

Still referring to block 504, in yet another exemplary methodology, CPU station 24 may have access to historical production field data. In such cases, the location of the ICE modules along tubulars 16,18 may be pre-selected based upon the historical data. In addition, CPU station 24 may also activate these strategically placed ICE modules more frequently to, for example, enhance production near wells where water is being pumped into the formation. In other methodologies, CPU station 24 may activate certain ICE modules 22 (e.g. those modules that detect pH or acids) when performing production enhancement techniques employing acids. Moreover, other methodologies may utilize mathematical techniques, such as, for example, artificial intelligence or neural networks, to suggest or determine the selection, order, duration, and frequency of various measurements along the network.

In certain exemplary methodologies, the activation of one or more of the ICE modules and the transmission of the data may only last 10 seconds, all occurring at a time T1. Thereafter, the activated ICE module(s) are then deactivated at time T2, and another set is then activated at time T3, and the process continues as desired. Furthermore, at any given time during sensing operations, the CPU station, via the power management module, continuously monitors the total power consumption of the network. In doing so, the CPU station will activate and deactivate the selected ICE modules such that the total power allotment for the network is not exceeded.

Accordingly, the present invention provides an ICE-based sensor network that may be utilized in harsh and/or power constrained environments to provide real time data related to various compounds or fluid characteristics. The ICE structures utilized in the ICE modules of the present invention provide a number of advantages. First, the compact nature of the ICE structures allows multiple ICE modules to be distributed throughout a network. As a result, in certain embodiments, the total volume of the ICE module is only a few cubic inches. Second, the ICE modules have long life, lower power requirements, and relatively low costs, thus making the present invention very attractive commercially. During testing of the present invention, the expected lifetime of an ICE module was expected on the order of 10-20 years of continuous operation under downhole well conditions. In some embodiments, power consumption was found to be roughly 2 watts continuous for each ICE module, and substantially less if periodic or round-robin activation/detection techniques are employed. Moreover, the compactness and low energy consumption of the ICE modules make them very attractive for permanent or battery operated applications, in addition to classic above ground or electronically tethered applications.

An exemplary embodiment of the present invention provides an optical sensor network, comprising a plurality of ICE modules distributed along the network, the plurality of ICE modules being configured to optically interact with a sample to determine a characteristic of the sample; and a signal processor communicably coupled to the plurality of ICE modules. In another embodiment, the network is distributed along a wellbore. In another, the network further comprises a plurality of tubulars extending along the wellbore in which wellbore fluid flows, wherein the plurality of ICE modules are configured to optically interact with the wellbore fluid to determine a characteristic of the wellbore fluid. In another, the signal processor comprises a power management module to selectively activate and deactivate one or more of the plurality of ICE modules.

In yet another, the plurality of ICE modules are permanently affixed to the tubulars. In another, the plurality of ICE modules are removably affixed to the tubulars. In yet another, the plurality of ICE modules each comprise a transmitter to transmit data related to the characteristic of the sample in real-time. In another, the plurality of ICE modules comprise on-board battery packs. In yet another, the network further comprises a power source positioned at a surface location to supply power to the plurality of ICE modules. Another network further comprises a power generator positioned downhole along the wellbore to supply power to the plurality of ICE modules. In another, the plurality of ICE modules are communicably coupled to one another in a round-robin fashion.

An exemplary methodology of the present invention provides a method utilizing an optical sensor network, the method comprising distributing a plurality of Integrated Computational Element (“ICE”) modules along the network; optically interacting with a sample using the plurality of ICE modules; and determining a characteristic of the sample based upon the optical interaction. In another, the network is distributed along a wellbore. In yet another, distributing the plurality of ICE modules further comprises positioning the plurality of ICE modules along a plurality of tubulars extending along the wellbore, wherein the plurality of ICE modules are configured to optically interact with wellbore fluid to determine a characteristic of the wellbore fluid. Another method further comprises selectively activating and deactivating one or more of the plurality of ICE modules. In another, the selective activation and deactivation is conducted in a round-robin fashion.

In yet another, the selective activation and deactivation is conducted based upon at least one of the following: characteristic data received from one or more ICE modules in real-time; or historical data related to a wellbore in which the network is distributed. In another, distributing the plurality of ICE modules further comprises permanently affixing the plurality of ICE modules to the tubulars. In yet another, distributing the plurality of ICE modules further comprises removably affixing the plurality of ICE modules to the tubulars. In another, distributing the plurality of ICE modules further comprises determining a location of the plurality of ICE modules based upon historical data related to the wellbore.

Yet another method further comprises detecting an alert condition based upon the characteristic of the sample; and performing at least one of the following generating an alert signal that corresponds to the alert condition in real-time; generating a network report; or performing remedial action. Another method further comprises activating a first set of the plurality of ICE modules at time T1; deactivating the first set of the plurality of ICE modules at time T2; and activating a second set of the plurality of the ICE modules at time T3. Yet another method further comprises determining a total power allotment for the network; and selectively activating and deactivating one or more of the plurality of ICE modules based upon the total power allotment for the network. In another, distributing the plurality of ICE modules further comprises at least one of embedding ICE modules into a formation of the wellbore; deploying ICE modules within wellbore cement; or floating ICE modules in and out of the wellbore, wherein the plurality of ICE modules are configured to optically interact with wellbore fluid to determine a characteristic of the wellbore fluid.

Although various embodiments and methodologies have been shown and described, the invention is not limited to such embodiments and methodologies, and will be understood to include all modifications and variations as would be apparent to one ordinarily skilled in the art. For example, although the ICE modules are described herein as being deployed along tubulars, they may also be utilized in open hole applications, such as, for example, embedding them into the formation, including them in the cement, or floating them in and out of the wellbore using ballast techniques. Therefore, it should be understood that the invention is not intended to be limited to the particular forms disclosed. Rather, the intention is to cover all modifications, equivalents and alternatives falling within the spirit and scope of the invention as defined by the appended claims.

What is claimed is:

1. An optical sensor network, comprising:
a plurality of Integrated Computational Element (“ICE”) modules distributed along the network, the plurality of ICE modules being configured to optically interact with a sample to determine a characteristic of the sample; and
a signal processor communicably coupled to the plurality of ICE modules.

2. A network as defined in claim 1, wherein the network is distributed along a wellbore.

3. A network as defined in claim 2, further comprising a plurality of tubulars extending along the wellbore in which wellbore fluid flows, wherein the plurality of ICE modules are configured to optically interact with the wellbore fluid to determine a characteristic of the wellbore fluid.

4. A network as defined in claim 1, wherein the signal processor comprises a power management module to selectively activate and deactivate one or more of the plurality of ICE modules.

5. A network as defined in claim 3, wherein the plurality of ICE modules are permanently affixed to the tubulars.

6. A network as defined in claim 3, wherein the plurality of ICE modules are removably affixed to the tubulars.

7. A network as defined in claim 1, wherein the plurality of ICE modules each comprise a transmitter to transmit data related to the characteristic of the sample in real-time.

8. A network as defined in claim 1, wherein the plurality of ICE modules comprise on-board battery packs.

9. A network as defined in claim 1, further comprising a power source positioned at a surface location to supply power to the plurality of ICE modules.

10. A network as defined in claim 3, further comprising a power generator positioned downhole along the wellbore to supply power to the plurality of ICE modules.

11. A network as defined in claim 1, wherein the plurality of ICE modules are communicably coupled to one another in a round-robin fashion.

12. A method utilizing an optical sensor network, the method comprising:
distributing a plurality of Integrated Computational Element (“ICE”) modules along the network;
optically interacting with a sample using the plurality of ICE modules; and
determining a characteristic of the sample based upon the optical interaction.

13. A method as defined in claim 12, wherein the network is distributed along a wellbore.

14. A method as defined in claim 13, wherein distributing the plurality of ICE modules further comprises positioning the plurality of ICE modules along a plurality of tubulars extending along the wellbore, wherein the plurality of ICE modules are configured to optically interact with wellbore fluid to determine a characteristic of the wellbore fluid.

15. A method as defined in claim 12, further comprising selectively activating and deactivating one or more of the plurality of ICE modules.

16. A method as defined in claim 15, wherein the selective activation and deactivation is conducted in a round-robin fashion.

17. A method as defined in claim 15, wherein the selective activation and deactivation is conducted based upon at least one of the following:
characteristic data received from one or more ICE modules in real-time; or historical data related to a wellbore in which the network is distributed.

18. A method as defined in claim 14, wherein distributing the plurality of ICE modules further comprises permanently affixing the plurality of ICE modules to the tubulars.

19. A method as defined in claim 14, wherein distributing the plurality of ICE modules further comprises removably affixing the plurality of ICE modules to the tubulars.

20. A method as defined in claim 14, wherein distributing the plurality of ICE modules further comprises determining a location of the plurality of ICE modules based upon historical data related to the wellbore.

21. A method as defined in claim 12, further comprising:
detecting an alert condition based upon the characteristic of the sample; and
performing at least one of the following:
generating an alert signal that corresponds to the alert condition in real-time;
generating a network report; or
performing remedial action.

22. A method as defined in claim 12, further comprising:
activating a first set of the plurality of ICE modules at time T1;
deactivating the first set of the plurality of ICE modules at time T2; and
activating a second set of the plurality of the ICE modules at time T3.

23. A method as defined in claim 12, further comprising:
determining a total power allotment for the network; and
selectively activating and deactivating one or more of the plurality of ICE modules based upon the total power allotment for the network.

24. A method as defined in claim 13, wherein distributing the plurality of ICE modules further comprises at least one of:
embedding ICE modules into a formation of the wellbore;
deploying ICE modules within wellbore cement; or
floating ICE modules in and out of the wellbore,
wherein the plurality of ICE modules are configured to optically interact with wellbore fluid to determine a characteristic of the wellbore fluid.
